(19) United States
(12) Patent Application Publication
(10) Pub. No.: US 2024/0278316 A1
(43) Pub. Date: Aug. 22, 2024

(54) Amorphous Alloy Soft Magnetic Powder, Dust Core, Magnetic Element, And Electronic Device

(71) Applicant: SEIKO EPSON CORPORATION, Tokyo (JP)

(72) Inventor: Mayu WATANABE, Hachinohe (JP)

(21) Appl. No.: 18/444,820

(22) Filed: Feb. 19, 2024

(30) Foreign Application Priority Data
Feb. 20, 2023 (JP) 2023-024067

(51) Int. Cl. B22F 1/08; B22F 1/05; B22F 1/065; B22F 3/02; B22F 3/24; C22C 38/00; C22C 38/02; C22C 38/10; C22C 38/12; C22C 38/16; H01F 1/153

(52) U.S. Cl. CPC B22F 1/08; B22F 1/05; B22F 1/065; B22F 3/02; B22F 3/24; C22C 38/002; C22C 38/008; C22C 38/02; C22C 38/10; C22C 38/12; C22C 38/16; H01F 1/15316; B22F 2003/248; B22F 2301/35; B22F 2304/10; B22F 2998/10; B22F 2999/00; C22C 2200/02; C22C 2202/02

(57) ABSTRACT

Amorphous alloy soft magnetic powder includes a composition expressed by a composition formula in atomic ratio (FeₓCo₁₋ₓ)_{100-(a+b)}(Si_{y}B_{1-y})ₐM_{b}, where M is at least one type selected from the group consisting of C, S, P, Sn, Mo, Cu, and Nb, 0.73≤x≤0.85, 0.02≤y≤0.10, 13.0≤a≤19.0, and 0≤b≤2.0; and impurities. The amorphous alloy soft magnetic powder has an average circularity of 0.85 or more, an average aspect ratio of 1.20 or less, and an average particle size of 10 μm or more and 40 μm or less. In the amorphous alloy soft magnetic powder, a rate of decrease D in magnetic permeability accompanying an increase in frequency is 15% or less.

The present application is based on, and claims priority from JP Application Serial Number 2023-024067, filed Feb. 20, 2023, the disclosure of which is hereby incorporated by reference herein in its entirety.

### BACKGROUND

### 1. Technical Field

The present disclosure relates to amorphous alloy soft magnetic powder, a dust core, a magnetic element, and an electronic device.

### 2. Related Art

JP-A-2022-111641 discloses amorphous alloy soft magnetic powder having a composition expressed by (Feₓ Co₍₁₋ₓ₎)_{(100-(a+b))}(Si_{y}B_{(1-y)})ₐM_{b}, where M is at least one type selected from the group consisting of C, S, P, Sn, Mo, Cu, and Nb, 0.73≤x≤0.85, 0.02≤y≤0.10, 13.0≤a≤19.0, and 0≤b≤2.0, the amorphous alloy soft magnetic powder having a coercive force of 24 [A/m] or more (0.3 [Oe] or more) and 199 [A/m] or less (2.5 [Oe] or less), and having a saturation magnetic flux density of 1.60 [T] or more and 2.20 [T] or less. Such amorphous alloy soft magnetic powder features a high saturation magnetic flux density and a low coercive force, and thus can contribute to downsizing and an increase in output of a magnetic element.

However, the amorphous alloy soft magnetic powder described in JP-A-2022-111641 has a relatively low magnetic permeability at a high frequency compared with a magnetic permeability at a low frequency. Therefore, with the amorphous alloy soft magnetic powder described in JP-A-2022-111641, a frequency band in which high magnetic permeability can be achieved is limited. Thus, improvement in terms of versatility and usability has been called for.

In view of this, there has been a demand for realization of amorphous alloy soft magnetic powder with which a compact featuring higher magnetic permeability over a wide frequency range can be produced.

### SUMMARY

Amorphous alloy soft magnetic powder according to an application example of the present disclosure includes a composition expressed by a composition formula in atomic ratio (FeₓCo₁₋ₓ)_{100-(a+b)}(Si_{y}B_{1-y})ₐM_{b}, where M is at least one type selected from the group consisting of C, S, P, Sn, Mo, Cu, and Nb, 0.73≤x≤0.85, 0.02≤y≤0.10, 13.0≤a≤19.0, and 0≤b≤2.0, and impurities, wherein the amorphous alloy soft magnetic powder has an average circularity of 0.85 or more, an average aspect ratio of 1.20 or less, and an average particle size of 10 μm or more and 40 μm or less, and in the amorphous alloy soft magnetic powder, a rate of decrease D in magnetic permeability accompanying an increase in frequency is 15% or less when the rate of decrease D is defined by (μₖ−μ_{M})/μₖ, where μₖ is a magnetic permeability at a frequency of 100 kHz, and μ_{M} is a magnetic permeability at a frequency of 100 MHz.

A dust core according to an application example of the present disclosure includes the amorphous alloy soft magnetic powder according to the application example of the present disclosure.

A magnetic element according to an application example of the present disclosure includes the dust core according to the application example of the present disclosure.

An electronic device according to an application example of the present disclosure includes the magnetic element according to the application example of the present disclosure.

### BRIEF DESCRIPTION OF THE DRAWINGS

FIG. 1 is a vertical cross-sectional view illustrating an example of an apparatus for producing amorphous alloy soft magnetic powder by a rotating water flow atomization method.

FIG. 2 is a plan view schematically illustrating a coil component of a toroidal type.

FIG. 3 is a transparent perspective view schematically illustrating a coil component of a closed magnetic circuit type.

FIG. 4 is a perspective view illustrating a mobile personal computer which is an electronic device including a magnetic element according to an embodiment.

FIG. 5 is a plan view illustrating a smartphone which is the electronic device including the magnetic element according to the embodiment.

FIG. 6 is a perspective view illustrating a digital still camera which is the electronic device including the magnetic element according to the embodiment.

FIG. 7 is a graph showing the frequency dependence of magnetic permeability measured for the amorphous alloy soft magnetic powder of Sample No. 3 and Sample No. 17.

### DESCRIPTION OF EMBODIMENTS

Amorphous alloy soft magnetic powder, a dust core, a magnetic element, and an electronic device of the present disclosure will be described in detail below based on a preferable embodiment illustrated in the accompanying drawings.

### 1. Amorphous Alloy Soft Magnetic Powder

The amorphous alloy soft magnetic powder according to an embodiment is an amorphous alloy powder exhibiting soft magnetism. The amorphous alloy soft magnetic powder can be applied to any use, and is formed by binding particles to each other, for example. With the powder, a dust core used for a magnetic element can be obtained.

Amorphous alloy soft magnetic powder according to an embodiment is powder including: a composition expressed by a composition formula in atomic ratio (FeₓCo₁₋ₓ)_{100-(a+b)}(Si_{y}B_{1-y})ₐM_{b}, and impurities.

M is at least one type selected from the group consisting of C, S, P, Sn, Mo, Cu, and Nb.

x, y, a, and b are respectively 0.73≤x≤0.85, 0.02≤y≤0.10, 13.0≤a≤19.0, and 0≤b≤2.0.

The amorphous alloy soft magnetic powder satisfies the following four conditions (a) to (d).
(a) Average circularity is 0.85 or more.
(b) Average aspect ratio is 1.20 or less.
(c) Average particle size is 10 μm or more and 40 μm or less.
(d) A rate of decrease D in magnetic permeability accompanying an increase in frequency is 15% or less when the rate of decrease D is defined by (μₖ−μ_{M}))/μₖ, where μₖ is the magnetic permeability at a frequency of 100 kHz, and μ_{M} is the magnetic permeability at a frequency of 100 MHz.

Such amorphous alloy soft magnetic powder is powder with which a compact featuring higher magnetic permeability over a wide frequency range can be produced. Therefore, by using such amorphous alloy soft magnetic powder, it is possible to obtain a magnetic element featuring high magnetic permeability regardless of the frequency range in which the magnetic element is used, and thus offering excellent versatility and usability.

### 1.1. Composition

Hereinafter, the composition of the amorphous alloy soft magnetic powder will be described in detail. As described above, the amorphous alloy soft magnetic powder according to the embodiment has a composition expressed by (FeₓCo₁₋ₓ)_{100-(a+b)}(Si_{y}B_{1-y})ₐM_{b}. This composition formula represents a ratio in a composition composed of at least five elements of Fe, Co, Si, B, and M.

Fe (iron) greatly affects the basic magnetic properties and mechanical properties of the amorphous alloy soft magnetic powder according to the embodiment.

The content of Fe, which is not particularly limited, is set in such a manner that Fe serves as the main component in the amorphous alloy soft magnetic powder, that is, has the highest ratio of the number of atoms. In the amorphous alloy soft magnetic powder according to the present embodiment, the content of Fe is preferably 61.0 mass % or more and 71.0 mass % or less, more preferably 63.0 mass % or more and 69.0 mass % or less, and even more preferably 65.0 mass % or more and 68.0 mass % or less. When the content of Fe falls below the lower limit value described above, the magnetic flux density of the amorphous alloy soft magnetic powder may be compromised depending on the composition. On the other hand, when the content of Fe exceeds the upper limit value described above, the amorphous structure may be difficult to stably form depending on the composition.

x represents a ratio of the number of Fe atoms to the total number of atoms, with the sum of the number of Fe atoms and the number of Co atoms being defined as 1. In the amorphous alloy soft magnetic powder according to the present embodiment, the ratio is 0.73≤x≤0.85. The ratio is preferably 0.75≤x≤0.83, and more preferably 0.77≤x≤0.81.

Cobalt (Co) can increase the saturation magnetic flux density of the amorphous alloy soft magnetic powder.

The ratio of the number of Co atoms to the total number of atoms is 0.15≤1−x≤0.27, with the sum of the number of Fe atoms and the number of Co atoms being defined as 1. The ratio is preferably 0.17≤1−x≤0.25, and more preferably 0.19≤1−x≤0.23. With 1−x set within the above range, the saturation magnetic flux density of the amorphous alloy soft magnetic powder can be increased while suppressing an increase in coercive force.

Note that 1−x falling below the lower limit value described above leads to excessively small content of Co with respect to the content of Fe, resulting in failure to sufficiently increase the saturation magnetic flux density. On the other hand, 1−x exceeding the upper limit value described above leads to excessively large content of Co with respect to the content of Fe, resulting in difficulty in forming the amorphous structure and an increase in the coercive force.

The content of Co is preferably 12.0 atom % or more and 22.0 atom % or less, and is more preferably 15.0 atom % or more and 19.0 atom % or less.

Silicon (Si) promotes amorphization and increases the magnetic permeability of the amorphous alloy soft magnetic powder when the amorphous alloy soft magnetic powder is produced from a raw material. Thus, a low coercive force and a high magnetic permeability can be achieved.

Boron (B) promotes amorphization when the amorphous alloy soft magnetic powder is produced from a raw material. In particular, by using Si and B in combination, it is possible to synergistically promote amorphization based on the difference in the atomic radius between Si and B. Thereby, sufficiently low coercive force and sufficiently high magnetic permeability can be achieved.

y represents a ratio of the number of Si atoms to the total number of atoms, with the sum of the number of Si atoms and the number of B atoms being defined as 1. In the amorphous alloy soft magnetic powder according to the present embodiment, the ratio is 0.02≤y≤0.10. The ratio is preferably 0.04≤y≤0.08, and more preferably 0.05≤y≤0.07. With y set to be within the above range, the balance between the number of Si atoms and the number of B atoms can be optimized. Thus, even when the concentrations of Fe and Co are relatively high, amorphization can be sufficiently achieved. Therefore, with y set to be within the above range, the coercive force can be reduced without compromising the high saturation magnetic flux density.

When y falls below the lower limit value described above and when y exceeds the upper limit value described above, the balance between the number of Si atoms and the number of B atoms is compromised. Therefore, amorphization cannot be promoted with a composition ratio in which the concentrations of Fe and Co are relatively high.

a influences the balance between Si and B and Fe and Co. In the amorphous alloy soft magnetic powder according to the present embodiment, the value of a is 13.0≤a≤19.0. The value is preferably 14.0≤a≤18.0, and more preferably 15.0≤a≤17.0. With a set to be within the above range, the balance between Si and B that mainly promote amorphization and the balance between Fe and Co that mainly increase the saturation magnetic flux density are optimized.

When a falls below the lower limit value described above, the amount ratio of Si and B is low and the amount ratio of Fe and Co is high, rendering the amorphization difficult. On the other hand, when a exceeds the upper limit value described above, the amount ratio of Si and B is high and the amount ratio of Fe and Co is low, rendering sufficient increase in the saturation magnetic flux density difficult.

The content of Si is preferably 0.40 atom % or more and 1.80 atom % or less, and is more preferably 0.80 atom % or more and 1.50 atom % or less.

The content of B is preferably 11.0 atom % or more and 18.0 atom % or less, and is more preferably 14.0 atom % or more and 16.0 atom % or less.

M is at least one type selected from the group consisting of C, S, P, Sn, Mo, Cu, and Nb. With a predetermined amount of M contained, the saturation magnetic flux density can be further increased. In addition, when two or more kinds of the above-described elements are contained as M, the saturation magnetic flux density can be further increased compared with a case where M is not contained or a case where one type of M is contained.

b represents the content of M. When a plurality of elements are contained as M, b is the total content of the plurality of elements. In the amorphous alloy soft magnetic powder according to the present embodiment, the content is 0≤b≤2.0. The content is preferably 0.5≤b≤1.5, and more preferably 0.7≤b≤1.2. With b set to be within the above range, the saturation magnetic flux density can be increased without inhibiting amorphization.

When b falls below the lower limit value described above, the above effect may not be sufficiently obtained. On the other hand, when b exceeds the upper limit value described above, amorphization is inhibited.

The amorphous alloy soft magnetic powder according to the embodiment may include impurities in addition to the composition expressed by (Feₓ Co₁₋ₓ)_{100-(a+b)}(Si_{y}B_{1-y})ₐM_{b}. Examples of the impurities include all elements other than those described above, and the total content of the impurities is preferably 1.0 mass % or less, more preferably 0.2 mass % or less, and still more preferably 0.1 mass % or less.

The composition of the amorphous alloy soft magnetic powder according to the embodiment is as described in detail above. The composition and impurities are identified by the following analysis method.

Examples of the analysis method include Iron and steel-Atomic absorption spectrometric method specified in JIS G 1257:2000, Iron and steel-ICP atomic emission spectrometric method specified in JIS G 1258:2007, Iron and steel-Method for spark discharge atomic emission spectrometric analysis specified in JIS G 1253:2002, Iron and steel-Method for X-ray fluorescence spectrometric analysis specified in JIS G 1256:1997, gravimetry, titrimetry, and absorption photometry specified in JIS G 1211 to G 1237, and the like.

Specifically, a solid atomic emission spectrometer, in particular, spark discharge emission spectrometer available from SPECTRO Analytical Instruments GmbH (model: SPECTROLAB, type: LAVMB08A), as well as ICP device, type CIROS120 available from Rigaku Co., Ltd. may be used for example.

When carbon (C) and sulfur (S) are identified, particularly, oxygen flow combustion (high-frequency induction heating furnace combustion)-infrared absorption method specified in JIS G 1211:2011 may also be used. Specifically, a carbon sulfur analyzer CS-200 available from LECO Japan Corporation is used.

Furthermore, when N (nitrogen) and O (oxygen) are identified, particularly, Iron and steel-Methods for determination of nitrogen content specified in JIS G 1228:1997 or General rules for determination of oxygen in metallic materials specified in JIS Z 2613:2006 may also be used. Specifically, an oxygen nitrogen analyzer TC-300/EF-300 available from LECO Japan Corporation is used.

### 1.2. (a) Average Circularity

The average circularity of the amorphous alloy soft magnetic powder according to the embodiment is 0.85 or more, preferably 0.88 or more and 1.00 or less, and more preferably 0.90 or more and 0.95 or less. With this configuration, amorphous alloy soft magnetic powder featuring particularly good fillability at the time of compacting is achieved. As a result, a compact featuring high magnetic permeability can be produced. An insulating coating can be formed at the particle surface of the amorphous alloy soft magnetic powder, uniformly and thinly, without unevenness. Thus, a green compact featuring excellent insulation between particles, magnetic permeability, and saturation magnetic flux density can be produced.

The average circularity falling below the lower limit value described above leads to compromised fillability of the amorphous alloy soft magnetic powder at the time of compacting, resulting in compromised magnetic permeability of the green compact. In addition, the uniformity of the thickness of the insulating coating may be compromised, and the film thickness may become large. On the other hand, the average circularity may exceed the upper limit value described above, but such average circularity may increase the difficulty in the production.

The average circularity of the amorphous alloy soft magnetic powder is measured as follows.

First, an image (secondary electron image) of the amorphous alloy soft magnetic powder is captured using a scanning electron microscope (SEM). Next, the obtained image is read into image processing software. As the image processing software, for example, image analysis type particle size distribution measurement software “Mac-View” available from Mountech Co., Ltd. or the like is used. The imaging magnification is adjusted so that 50 to 100 particles are included in one captured image. Then, a plurality of images are acquired so as to obtain a total of 300 or more particle images.

Next, using software, the circularities of the 300 or more particle images are calculated and an average value is obtained. The average value obtained is the average circularity of the amorphous alloy soft magnetic powder. With the circularity defined as e, the area of the particle image defined as S, and the peripheral length of the particle image defined as L, the circularity e is obtained by the following equation.

E=4πS/L²

### 1.3. (b) Average Aspect Ratio

The average aspect ratio of the amorphous alloy soft magnetic powder according to the embodiment is 1.20 or less, preferably 1.18 or less, and more preferably 1.15 or less. When the average aspect ratio of the amorphous alloy soft magnetic powder is within the above range, amorphous alloy soft magnetic powder featuring particularly high fillability at the time of compaction can be obtained. As a result, a compact featuring high magnetic permeability can be produced. An insulating coating can be formed at the particle surface of the amorphous alloy soft magnetic powder, uniformly and thinly, without unevenness. Thus, a green compact featuring excellent insulation between particles, magnetic permeability, and saturation magnetic flux density can be produced.

The average aspect ratio falling below the lower limit value described above leads to compromised fillability of the amorphous alloy soft magnetic powder at the time of compacting. In addition, the uniformity of the thickness of the insulating coating may be compromised, and the film thickness may become large. On the other hand, the average aspect ratio may exceed the upper limit value described above, but such average aspect ratio may increase the difficulty in the production.

The average aspect ratio of the amorphous alloy soft magnetic powder is calculated as follows.

First, an image (secondary electron image) of the amorphous alloy soft magnetic powder is captured using a scanning electron microscope (SEM). Next, the obtained image is read into image processing software. As the image processing software, for example, image analysis type particle size distribution measurement software “Mac-View” available from Mountech Co., Ltd. or the like is used. The imaging magnification is adjusted so that 50 to 100 particles are included in one captured image. Then, a plurality of images are acquired so as to obtain a total of 300 or more particle images.

Next, using software, the aspect ratios of the 300 or more particle images are calculated and an average value is obtained. The average value obtained is the average aspect ratio of the amorphous alloy soft magnetic powder. The aspect ratio is determined by (major axis)/(minor axis), where the major axis is the maximum length of the particle image and the minor axis is the maximum length in a direction orthogonal to the direction in which the major axis extends.

### 1.4. (c) Average Particle Size

The average particle size of the amorphous alloy soft magnetic powder according to the embodiment is 10 μm or more and 40 μm or less, preferably 15 μm or more and 35 μm or less, and more preferably 20 μm or more and 30 μm or less. With this configuration, it is possible to obtain amorphous alloy soft magnetic powder featuring high fillability at the time of compacting and capable of suppressing the eddy current loss in the green compact. As a result, a compact featuring high magnetic permeability and low iron loss can be produced.

When the average particle size of the amorphous alloy soft magnetic powder falls below the lower limit value described above, aggregation is likely to occur that leads to a decrease in the density of the green compact. On the other hand, when the average particle size of the amorphous alloy soft magnetic powder exceeds the upper limit value described above, the gap between particles increases, and thus the density of the green compact decreases. In addition, iron loss in the green compact may increase.

The average particle size refers to a particle size D50 corresponding to the cumulative frequency of 50% from the small diameter side in the volume-based cumulative particle size distribution of the amorphous alloy soft magnetic powder, obtained using a laser diffraction-type particle size distribution measuring device.

The amorphous alloy soft magnetic powder satisfying (a) to (c) described above features particularly high fillability at the time of compacting. As a result, a compact featuring a high magnetic permeability is obtained. Such a compact features a high magnetic permeability over a wide frequency range. Thus, a compact featuring excellent versatility and usability is obtained.

### 1.5. (d) Rate of Decrease in Magnetic Permeability

The rate of decrease D in magnetic permeability accompanying an increase in frequency is (μₖ−μ_{M}))/μₖ, where μₖ is the magnetic permeability of the amorphous alloy soft magnetic powder at a frequency of 100 kHz, and μ_{M} is the magnetic permeability at a frequency of 100 MHz. The rate of decrease D in magnetic permeability of the amorphous alloy soft magnetic powder according to the embodiment is 15% or less, preferably 13% or less, and more preferably 11% or less. When the rate of decrease D in magnetic permeability is within the above range, a change in magnetic permeability from a relatively low frequency of 100 kHz to a relatively high frequency of 100 MHz is small. The compact produced using the amorphous alloy soft magnetic powder according to the embodiment features a small change in magnetic permeability over a wide frequency range that is three orders of magnitude as described above, and thus is particularly excellent in versatility and usability. Thus, it is possible to obtain a compact that can be applied to various applications at different frequencies.

Each of the magnetic permeability μₖ and the magnetic permeability μ_{M} is preferably 15.0 or more, and more preferably 17.0 or more. Such amorphous alloy soft magnetic powder contributes to realization of a compact that has magnetic flux density hardly saturated even when a high magnetic field is applied, that is, has a high saturation magnetic flux density. The upper limit value of the magnetic permeability is not particularly limited, but is set to 30.0 or less for the sake of stable production.

The magnetic permeability of the amorphous alloy soft magnetic powder is measured for a green compact produced using the amorphous alloy soft magnetic powder. The magnetic permeability of the green compact is, for example, a relative magnetic permeability obtained from a self-inductance of a closed magnetic circuit magnetic core coil fabricated on a toroidal green compact, that is, an effective magnetic permeability. The magnetic permeability is measured using an impedance analyzer at a measurement frequency of 100 kHz or 100 MHz. The number of turns of the winding is seven, and the wire diameter of the winding is 0.6 mm. The size of the green compact is defined by the outer diameter of φ 14 mm, the inner diameter of φ⁸ mm, and the thickness of 3 mm, and the compacting force is 294 MPa.

### 1.6. Other Properties

The degree of amorphization in the particles of the amorphous alloy soft magnetic powder can be identified based on the degree of crystallization. The degree of crystallization in the particles of the amorphous alloy soft magnetic powder is calculated from a spectrum obtained by X-ray diffraction of the amorphous alloy soft magnetic powder based on the following equation.

$$Degree of crystallization = \{ intensity derived from crystal / ( intensity derived from crystal + intensity derived from amorphous ) \} \times 100$$

As the X-ray diffraction apparatus, for example, RINT2500V/PC available from Rigaku Co., Ltd. is used.

The degree of crystallization thus measured is preferably 15% or less, and more preferably 10% or less. With this configuration, the soft magnetism is more eminently improved by amorphization. As a result, an amorphous alloy soft magnetic powder featuring sufficiently high magnetic permeability and low coercive force can be obtained. If the degree of crystallization can be reduced to be within the above range, amorphous alloy soft magnetic powder enabling production of a green compact featuring high magnetic permeability over a wide frequency range can be obtained.

The coercive force of the amorphous alloy soft magnetic powder according to the embodiment is preferably 24 [A/m] or more (0.3 [Oe] or more) and 199 [A/m] or less (2.5 [Oe] or less), more preferably 40 [A/m] or more (0.5 [Oe] or more) and 175 [A/m] or less (2.2 [Oe] or less), and further preferably 56 [A/m] or more (0.7 [Oe] or more), and 159 [A/m] or less (2.0 [Oe] or less).

By using the amorphous alloy soft magnetic powder having such a relatively small coercive force as described above, it is possible to produce a compact capable of sufficiently suppressing hysteresis loss even at a high frequency.

When the coercive force falls below the lower limit value described above, it is difficult to stably produce an amorphous alloy soft magnetic powder featuring such a low coercive force, and when the coercive force is excessively increased, the saturation magnetic flux density may be affected and compromised. On the other hand, when the coercive force exceeds the upper limit value described above, a huge hysteresis loss occurs at a high frequency, which may lead to a huge iron loss of the dust core.

The coercive force of the amorphous alloy soft magnetic powder can be measured by, for example, a vibrating sample magnetometer such as TM-VSM1230-MHHL available from Tamagawa Seisakusho Co., Ltd.

The saturation magnetic flux density of the amorphous alloy soft magnetic powder according to the embodiment is preferably 1.60 [T] or more and 2.20 [T] or less, more preferably 1.60 [T] or more and 2.10 [T] or less, and still more preferably 1.65 [T] or more and 2.00 [T] or less.

By using the amorphous alloy soft magnetic powder having a relatively large saturation magnetic flux density as described above, a dust core having a high saturation magnetic flux density can be obtained. According to such a dust core, it is possible to achieve downsizing and an increase in output of the magnetic element.

The saturation magnetic flux density falling below the lower limit value described above may render the downsizing and increase in output of the magnetic element difficult. On the other hand, when the saturation magnetic flux density exceeds the upper limit value described above, it is difficult to stably produce an amorphous alloy soft magnetic powder featuring such a saturation magnetic flux density, and when the saturation magnetic flux density is excessively increased, the coercive force may be affected and increase.

The saturation magnetic flux density of the amorphous alloy soft magnetic powder is measured by the following method.

First, the true density p of the soft magnetic powder is measured using a gas displacement pycnometry, AccuPyc1330, available from Micromeritics Co., Ltd. Next, the maximum magnetization Mm of the soft magnetic powder is measured using a vibrating sample magnetometer, VSM system TM-VSM1230-MHHL available from Tamagawa Seisakusho Co., Ltd. Then, a saturation magnetic flux density Bs is calculated by the following equation.

$$Bs = 4 π / 10000 \times ρ \times Mm$$

The apparent density and the tap density of the amorphous alloy soft magnetic powder are preferably within predetermined ranges. Specifically, when the apparent density [g/cm³] of the amorphous alloy soft magnetic powder is set to 100, the tap density [g/cm³] is preferably 103 or more and 120 or less, more preferably 105 or more and 115 or less, and still more preferably 107 or more and 113 or less. Such amorphous alloy soft magnetic powder can be regarded as powder that is relatively difficult to be filled without tapping (vibration) and easy to be filled by tapping. Therefore, as long as the tap density is within the above range, the amorphous alloy soft magnetic powder can be regarded as powder featuring a relatively small number of irregular-shaped particles and high fillability (fluidity).

The apparent density of the amorphous alloy soft magnetic powder is preferably 4.55 [g/cm³] or more and 4.80 [g/cm³] or less, more preferably 4.58 [g/cm³] or more and 4.70 [g/cm³] or less.

The tap density of the amorphous alloy soft magnetic powder is preferably 4.95 [g/cm³] or more and 5.30 [g/cm³] or less, more preferably 5.00 [g/cm³] or more and 5.20 [g/cm³] or less.

When the apparent density and the tap density of the amorphous alloy soft magnetic powder are within the above ranges, the magnetic permeability and the saturation magnetic flux density of the compact can be particularly increased.

The relative value of the tap density falling below the lower limit value described above leads to compromised fillability of the amorphous alloy soft magnetic powder at the time of compacting of the amorphous alloy soft magnetic powder to obtain a compact. On the other hand, the relative value of the tap density exceeding the upper limit value described above may lead to a large shrinkage ratio at the time of compacting of the amorphous alloy soft magnetic powder to obtain a compact. For this reason, the compact may be deformed, and the dimensional accuracy may be compromised.

The apparent density of the amorphous alloy soft magnetic powder is measured in accordance with the metal powder-apparent density measurement method specified in JIS Z 2504:2012.

The tap density of the amorphous alloy soft magnetic powder is measured in accordance with the metal powder-tap density measurement method specified in JIS Z 2512:2012.

A compact obtained by mixing the amorphous alloy soft magnetic powder according to the embodiment with 2 mass % of epoxy resin, drying the resultant powder at 50° C. for an hour to obtain granulated powder, pressing the granulated powder at 294.2 MPa (3 t/cm²) to obtain a green compact, and heating and curing the green compact at 150° C. for three hours has a relative density of preferably 65% or more, more preferably 66% or more, and even more preferably 67% or more. As long as the relative density of the compact is within the above range, the occupancy of the resin and the gap in the compact are sufficiently suppressed. As a result, sufficiently high occupancy of the amorphous alloy can be obtained. Thus, even higher magnetic permeability and saturation magnetic flux density of the compact can be achieved. The upper limit value, which may not be particularly set, is preferably 72% or less, more preferably 70% or less, for the sake of the mechanical strength of the green compact and the insulation between particles. The relative density is obtained by dividing the density of the green compact by the true density of the amorphous alloy soft magnetic powder.

In the amorphous alloy soft magnetic powder according to the embodiment, the compact prepared by the above method has an iron loss of preferably 11000 [kW/m³] or less, and more preferably 10500 [kW/m³] or less when the iron loss is measured with a maximum magnetic flux density of 50 mT and at a measurement frequency of 900 kHz. With this configuration, a magnetic element featuring high efficiency can be obtained.

The saturation magnetic flux density Bs of the amorphous alloy soft magnetic powder according to the embodiment is preferably 1.5 T or more and 2.2 T or less, more preferably 1.6 T or more and 1.8 T or less. Thereby, a magnetic element featuring high saturation magnetic flux density can be obtained.

The saturation magnetic flux density Bs of the amorphous alloy soft magnetic powder is obtained as follows.

The maximum magnetization of the amorphous alloy soft magnetic powder measured using a vibrating sample magnetometer is defined by Mm [emu/g], and the true density of the amorphous alloy soft magnetic powder is defined by ρ [g/cm³]. Under this condition, the saturation magnetic flux density Bs of the amorphous alloy soft magnetic powder is obtained by Bs=4 π/10000×ρ×Mm.

The amorphous alloy soft magnetic powder according to the embodiment may be mixed with another soft magnetic powder or a non-soft magnetic powder and the mixed powder thus obtained may be used for various applications.

### 2. Method of Producing Amorphous Alloy Soft Magnetic Powder

Next, a method of producing the amorphous alloy soft magnetic powder will be described.

The amorphous alloy soft magnetic powder may be produced by any method. Examples of the production method include an atomization method such as a water atomization method, a gas atomization method, and a rotating water flow atomization method, as well as various powdering methods such as a reduction method, a carbonyl method, and a pulverization method.

Examples of the atomization method includes a water atomization method, a gas atomization method, and a rotating water flow atomization method, which are different from each other in terms of the type of the cooling medium and the apparatus configuration. Among the above methods, the amorphous alloy soft magnetic powder is preferably produced by the atomization method, more preferably produced by the water atomization method or the rotating water flow atomization method, and still more preferably produced by the rotating water flow atomization method. The atomization method is a method in which a melted raw material collides with a fluid such as liquid or gas jetted at a high speed to be pulverized and cooled. Thus, powder is produced. With such an atomization method, it is possible to efficiently produce amorphous alloy soft magnetic powder that is satisfactorily amorphized and features excellent fillability.

The “water atomization method” is a method of producing metal powder by using liquid such as water or oil as cooling liquid. In the method, the liquid is injected in an inverted conical shape so as to converge at one point, and molten metal flows down toward the converging point, to collide with the liquid.

On the other hand, according to the rotating water flow atomization method, since the molten metal can be cooled at an extremely high speed, the amorphization can be particularly facilitated.

The cooling rate of the molten metal for producing the amorphous alloy soft magnetic powder is preferably higher than 10⁶ [K/sec] and more preferably 10⁷ [K/sec] or higher. Thus, amorphous alloy soft magnetic powder is obtained with amorphization sufficiently achieved. That is, the amorphization can be achieved even with the composition in which the content of Fe or Co is relatively high. In particular, according to the rotating water flow atomization method, a cooling rate of 10⁷ [K/sec] or higher can be easily achieved.

The method for producing the amorphous alloy soft magnetic powder by the rotating water flow atomization method will be further described below.

In the rotating water flow atomization method, the cooling liquid is jetted and supplied along the inner circumference surface of the cooling cylinder, and swirls along the inner circumference surface of the cooling cylinder, whereby a cooling liquid layer is formed at the inner circumference surface. On the other hand, the raw material of the amorphous alloy soft magnetic powder is melted, and the jet of liquid or gas is blown onto the obtained molten metal naturally falling. The molten metal thus scattered is taken into the cooling liquid layer. As a result, the scattered and pulverized molten metal is rapidly cooled and solidified, whereby amorphous alloy soft magnetic powder is obtained.

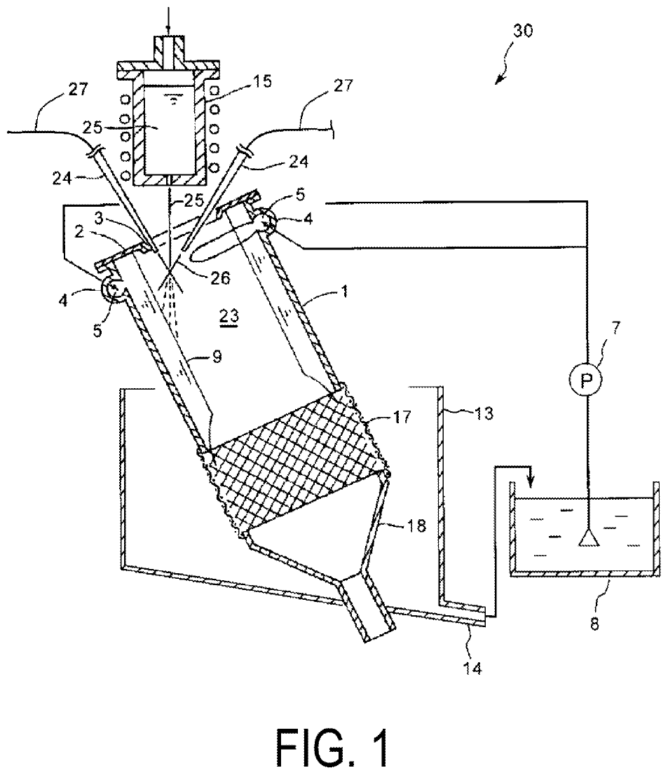

FIG. 1 is a vertical cross-sectional view illustrating an example of an apparatus for producing amorphous alloy soft magnetic powder by the rotating water flow atomization method.

A powder production apparatus 30 illustrated in FIG. 1 includes a cooling cylinder 1, a crucible 15, a pump 7, and a jet nozzle 24. The cooling cylinder 1 is a cylinder for forming a cooling liquid layer 9 on the inner circumference surface. The crucible 15 is a supply container in which molten metal 25 flows down into a space portion 23 on the inner side of the cooling liquid layer 9. The pump 7 supplies the cooling liquid to the cooling cylinder 1. From the jet nozzle 24, a gas jet 26 which divides the molten metal 25 flowing down in the form of a streamlet into liquid droplets.

The molten metal 25 is prepared according to the composition of the amorphous alloy soft magnetic powder.

The cooling cylinder 1 has a cylindrical shape, and is installed with the cylinder axis extending along the vertical direction or inclined at an angle of 30° or less with respect to the vertical direction.

The upper end opening of the cooling cylinder 1 is closed by a lid 2. An opening portion 3 for supplying the molten metal 25 flowing down to the space portion 23 of the cooling cylinder 1 is formed in the lid 2.

A cooling liquid jetting pipe 4 for jetting the cooling liquid to the inner circumference surface of the cooling cylinder 1 is provided on the upper part of the cooling cylinder 1. A plurality of discharge ports 5 of the cooling liquid jetting pipe 4 are provided at an equal interval along the circumferential direction of the cooling cylinder 1.

The cooling liquid jetting pipe 4 is coupled to a tank 8 through a pipe to which the pump 7 is coupled, and the cooling liquid in the tank 8 sucked up by the pump 7 is jetted and supplied into the cooling cylinder 1 through the cooling liquid jetting pipe 4. As a result, the cooling liquid gradually flows down while rotating along the inner circumference surface of the cooling cylinder 1, and thus the cooling liquid layer 9 is formed along the inner circumference surface. If necessary, a cooler may be interposed in the tank 8 or in the middle of the circulation flow path. In addition to water, oil such as silicone oil may be used as the cooling liquid, and various additives may be further added. Oxidation of the produced powder can be suppressed by removing dissolved oxygen in the cooling liquid in advance.

A cylindrical liquid draining net 17 is provided continuously with a lower portion of the cooling cylinder 1. A funnel-shaped powder collection container 18 is provided below the liquid draining net 17. Around the liquid draining net 17, a cooling liquid collection cover 13 is provided covering the liquid draining net body 17. A liquid discharge port 14 formed at the bottom of the cooling liquid collection cover 13 is coupled to the tank 8 through a pipe.

The jet nozzle 24 is provided in the space portion 23. The jet nozzle 24 is attached to the distal end of a gas supply pipe 27 inserted through the opening portion 3 of the lid 2, and is arranged with a jet port directed to the molten metal 25 in the form of a streamlet.

In order to produce the amorphous alloy soft magnetic powder in such a powder production apparatus 30, first, the pump 7 is operated, and the cooling liquid layer 9 is formed at the inner circumference surface of the cooling cylinder 1. Next, the molten metal 25 in the crucible 15 flows down into the space portion 23. When the gas jet 26 is blown to the molten metal 25 flowing down, the molten metal 25 is scattered, and the pulverized molten metal 25 is taken in the cooling liquid layer 9. As a result, the pulverized molten metal 25 is cooled and solidified, whereby the amorphous alloy soft magnetic powder is obtained.

In the rotating water flow atomization method, the cooling liquid is continuously supplied so that an extremely high cooling rate can be stably maintained. Thus, amorphization of the amorphous alloy soft magnetic powder to be produced is promoted.

The molten metal 25 atomized to a certain size by the gas jet 26 falls by inertia until it is taken into the cooling liquid layer 9. Thus, in this process, the liquid droplet is formed into a spherical shape. As a result, it is possible to produce amorphous alloy soft magnetic powder that has a relatively small diameter, but still has a good average circularity and a good average aspect ratio.

For example, the amount of the molten metal 25 flowing down from the crucible 15, which varies depending on the apparatus size and the like, is preferably more than 1.0 [kg/min] and 20.0 [kg/min] or less, and more preferably 2.0 [kg/min] or more and 10.0 [kg/min] or less. As a result, the amount of the molten metal 25 flowing down in a certain time can be optimized, and thus the amorphous alloy soft magnetic powder with sufficient amorphization can be efficiently produced. Furthermore, it is possible to increase the cooling rate of the molten metal 25 per unit amount and increase the degree of amorphization.

The pressure of the gas jet 26, which slightly varies depending on the configuration of the jet nozzles 24, is preferably 2.0 MPa or more and 20.0 MPa or less, and is more preferably 3.0 MPa or more and 10.0 MPa or less. As a result, the particle size of the molten metal 25 scattered is optimized, whereby the amorphous alloy soft magnetic powder with sufficient amorphization can be produced. Specifically, when the pressure of the gas jet 26 falls below the lower limit value described above, sufficiently fine scattering is difficult to achieve, and the particle size is likely to be large. As a result, the cooling rate of the inside of the liquid droplet may be compromised to lead to insufficient amorphization. On the other hand, when the pressure of the gas jet 26 exceeds the upper limit value described above, the particle size of the liquid droplets after scattering might be too small. As a result, the liquid droplets are gradually cooled by the gas jet 26, meaning that rapid cooling by the cooling liquid layer 9 cannot be performed. Thus, amorphization might be insufficient.

The flow rate of the gas jet 26, which is not particularly limited, is preferably 1.0 [Nm³/min] or more and 20.0 [Nm³/min] or less.

The pressure of the cooling liquid, to be supplied to the cooling cylinder 1, at the time of jetting is preferably about 5 MPa to 200 MPa, and is more preferably about 10 MPa to 100 MPa. With this configuration, the flow rate of the cooling liquid layer 9 is optimized, and the pulverized molten metal 25 is less likely to be deformed. As a result, amorphous alloy soft magnetic powder featuring even better fillability is obtained. In addition, the cooling rate of the molten metal 25 by the cooling liquid can be sufficiently increased.

In addition, in various atomization methods, it is possible to particularly increase the average circularity and decrease the average aspect ratio according to the casting temperature (melting temperature) of the raw material.

The casting temperature is preferably set to be Tm+100° C. or higher and Tm+300° C. or lower, and more preferably set to be Tm+180° C. or higher and Tm+270° C. or lower, where Tm [° C.] is the melting point of the constituent material of the amorphous alloy soft magnetic powder. With this configuration, a longer time during which the molten metal exists as the molten metal before being atomized and solidified by various atomization methods can be secured compared with the related art, and crystallization can be suppressed. As a result, amorphous alloy soft magnetic powder featuring a low degree of crystallization and particularly good average circularity and average aspect ratio is obtained.

When the casting temperature falls below the lower limit value described above, the average circularity and the average aspect ratio may fail to fall within the above ranges. On the other hand, the casting temperature exceeding the upper limit value described above may lead to a high degree of crystallization, and this may result in compromised magnetic permeability of the powder may decrease and high coercive force.

In the various atomization methods, molten metal flows down through a narrow opening and the resulting streamlet of the molten metal collides with a fluid jet. The outer diameter of the streamlet of the molten metal, which is not particularly limited, is preferably 3.0 mm or less, more preferably 0.3 mm or more and 2.0 mm or less, and even more preferably 0.5 mm or more and 1.5 mm or less. With this configuration, the fluid jet is likely to uniformly collide with the molten metal, whereby liquid droplets of an appropriate size are likely to be uniformly scattered. As a result, amorphous alloy soft magnetic powder with the average particle size described above, featuring excellent average circularity and average aspect ratio is obtained. The amount of the molten metal supplied in a certain period of time is reduced, leading to a uniform cooling rate of each liquid droplet, whereby the degree of crystallization is suppressed regardless of the particle size. As a result, amorphous alloy soft magnetic powder with which a green compact featuring high magnetic permeability over a wide frequency range can be produced can be obtained. Furthermore, a relatively narrow the particle size distribution is obtained, facilitating an increase in the ratio of the tap density to the apparent density.

The amorphous alloy soft magnetic powder produced may be classified as necessary. Examples of the classification method include dry classification such as sieve classification, inertial classification, and centrifugal classification, and wet classification such as sedimentation classification.

The amorphous alloy soft magnetic powder produced as described above may be subjected to a heat treatment if necessary. For conditions of the heat treatment, for example, a heating temperature is 200° C. or higher and 500° C. or lower, and a holding time at this temperature is two hours or shorter. Examples of the atmosphere of the heat treatment includes an inert gas atmosphere such as nitrogen or argon, a reducing gas atmosphere such as hydrogen or ammonia decomposition gas, a reduced-pressure atmosphere thereof, and the like.

If necessary, an insulating film may be formed at the surface of each particle of the soft magnetic powder obtained. Examples of the constituent material of the insulating film, which is not particularly limited, include inorganic materials such as phosphates such as magnesium phosphate, calcium phosphate, zinc phosphate, manganese phosphate, and cadmium phosphate, silicates such as sodium silicate, oxides such as a silicon oxide and aluminum oxide, and the like.

### 3. Dust Core and Magnetic Element

Next, the dust core and the magnetic element according to the embodiment will be described.

The magnetic element according to the embodiment can be applied to various magnetic elements including a magnetic core, such as a choke coil, an inductor, a noise filter, a reactor, a transformer, a motor, an actuator, an electromagnetic valve, and a generator for example. The dust core according to the embodiment can be applied to the magnetic core of these magnetic elements.

Two types of coil components will be representatively described below as examples of the magnetic element.

### 3.1. Toroidal Type

First, a coil component of a toroidal type which is an example of the magnetic element according to the embodiment will be described.

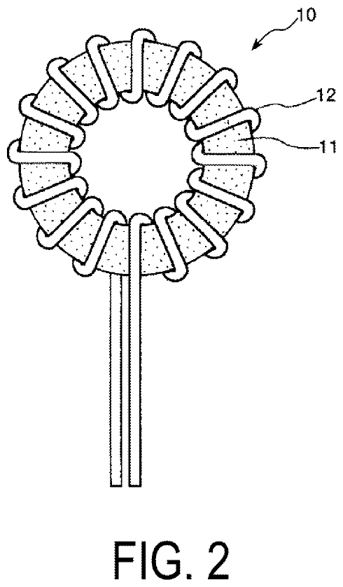

FIG. 2 is a plan view schematically illustrating a coil component of a toroidal type. A coil component 10 illustrated in FIG. 2 includes a ring-shaped dust core 11 and a conductive wire 12 wound around the dust core 11.

The dust core 11 is obtained by mixing the amorphous alloy soft magnetic powder described above with a binder, supplying the obtained mixture to a molding die, and pressing and molding the mixture. Therefore, the dust core 11 is a green compact containing the amorphous alloy soft magnetic powder according to the embodiment. Such a dust core 11 features high magnetic permeability over a wide frequency range. Therefore, an electronic device or the like including the coil component 10 including the dust core 11 can have a small size and feature high output.

The coil component 10 includes such a dust core 11, and thus contributes to downsizing and an increase in output of an electronic device.

Examples of the constituent material of the binder used for preparing the dust core 11 include organic materials such as silicone-based resin, epoxy-based resin, phenol-based resin, polyamide-based resin, polyimide-based resin, and polyphenylene sulfide-based resin, inorganic materials such as phosphates such as magnesium phosphate, calcium phosphate, zinc phosphate, manganese phosphate, and cadmium phosphate, and silicates such as sodium silicate, and the like.

Examples of the constituent material of the conductive wire 12 include highly conductive materials such as metal materials including Cu, Al, Ag, Au, Ni, and the like. If necessary, an insulating film may be provided on the surface of the conductive wire 12.

The shape of the dust core 11 is not limited to the ring shape illustrated in FIG. 2, and may be, for example, a partially notched ring shape, or a shape in which the shape in the longitudinal direction is linear for example.

The dust core 11 may contain soft magnetic powder other than the amorphous alloy soft magnetic powder according to the above-described embodiment and/or nonmagnetic powder as necessary.

### 3.2. Closed Magnetic Circuit Type

Next, a coil component of a closed magnetic circuit type which is an example of the magnetic element according to the embodiment will be described.

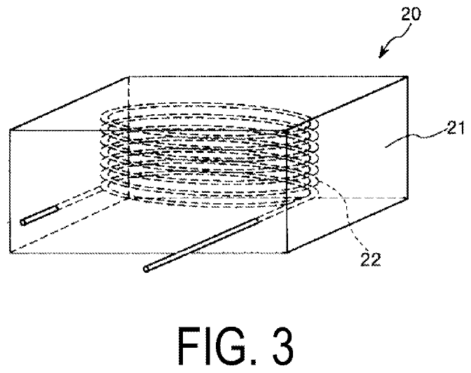

FIG. 3 is a transparent perspective view schematically illustrating the coil component of a closed magnetic circuit type.

The following description on the coil component of the closed magnetic circuit type mainly focuses on differences from the coil component of the toroidal type, and descriptions on similar matters will be omitted.

A coil component 20 illustrated in FIG. 3 includes a chip-shaped dust core 21 and a conductive wire 22 embedded in the dust core 21 and formed into a coil shape. Therefore, the dust core 21 is a green compact containing the amorphous alloy soft magnetic powder according to the embodiment. Such a dust core 21 features high magnetic permeability over a wide frequency range.

The coil component 20 includes such a dust core 21, and thus contributes to downsizing and an increase in output of an electronic device.

The dust core 21 may contain soft magnetic powder other than the amorphous alloy soft magnetic powder according to the above-described embodiment and/or nonmagnetic powder as necessary.

### 4. Electronic Device

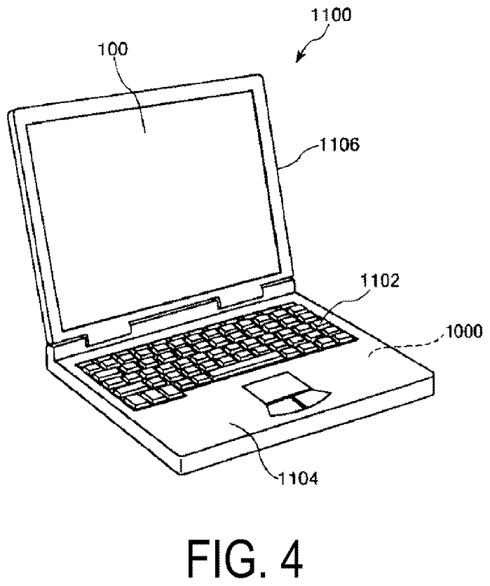

Next, an electronic device including the magnetic element according to the embodiment will be described based on FIG. 4 to FIG. 6.

FIG. 4 is a perspective view illustrating a mobile personal computer as an electronic device including the magnetic element according to the embodiment. A personal computer 1100 illustrated in FIG. 4 includes a main body section 1104 including a keyboard 1102 and a display unit 1106 including a display section 100. The display unit 1106 is rotatably supported by the main body section 1104 via a hinge structure section. A magnetic element 1000 such as a choke coil, an inductor, or a motor for a switching power supply is incorporated in the personal computer 1100 for example.

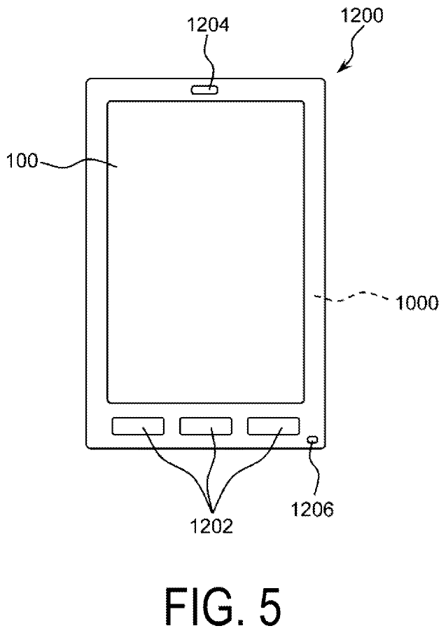

FIG. 5 is a plan view illustrating a smartphone as the electronic device including the magnetic element according to the embodiment. A smartphone 1200 illustrated in FIG. 5 includes a plurality of operation buttons 1202, an earpiece 1204, and a mouthpiece 1206. The display section 100 is disposed between the operation buttons 1202 and the earpiece 1204. The magnetic element 1000 such as an inductor, a noise filter, or a motor is built in the smartphone 1200 for example.

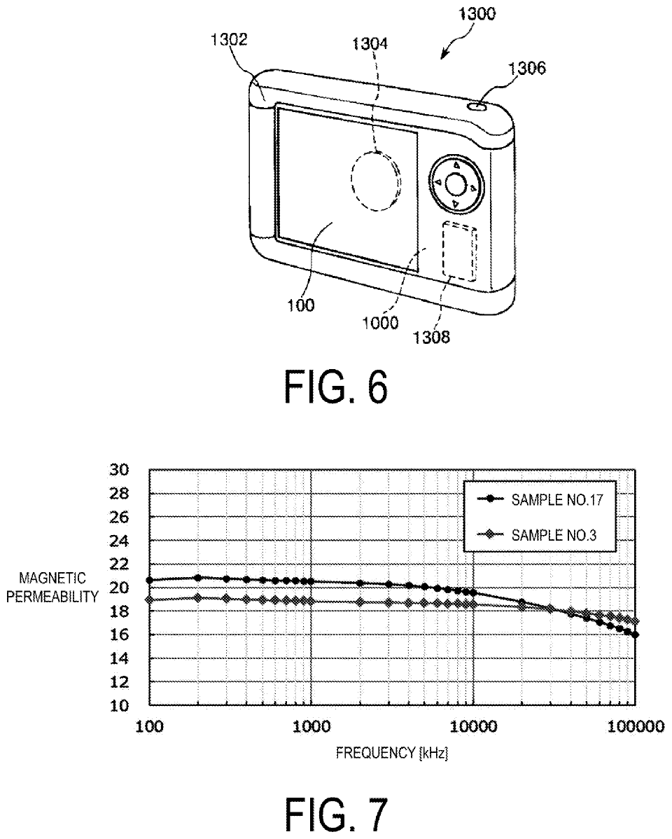

FIG. 6 is a perspective view illustrating a digital still camera which is an electronic device including the magnetic element according to the embodiment. A digital still camera 1300 generates a captured image signal by photoelectrically converting an optical image of a subject using an image sensor such as a charge coupled device (CCD).

The digital still camera 1300 illustrated in FIG. 6 includes the display section 100 provided on the back surface of a case 1302. The display section 100 serves as a finder that displays an electronic image of a subject. A light receiving unit 1304 including an optical lens, a CCD, and the like is provided on the front side of the case 1302, that is, on the back side in the drawing.

When the photographer confirms the subject image displayed on the display section 100 and presses a shutter button 1306, the captured image signal of the CCD at that time is transferred to and stored in a memory 1308. Such a digital still camera 1300 also incorporates the magnetic element 1000 such as an inductor or a noise filter for example.

In addition to the personal computer illustrated in FIG. 4, the smartphone illustrated in FIG. 5, and the digital still camera illustrated in FIG. 6, examples of the electronic device according to the embodiment include a mobile phone, a tablet terminal, a watch, an ink-jet discharge devices such as an ink-jet printer, a laptop personal computer, a television receiver, a video camera, a video tape recorder, a car navigation device, a pager, a videophone, a security television monitor, electronic binoculars, a POS terminal, an electronic thermometer, a sphygmomanometer, a blood glucose meter, an electrocardiogram measuring device, an ultrasonic diagnostic device, a medical device such as an electronic endoscope, a fish finder, various measuring devices, instruments for a vehicle, an aircraft, and a ship, a mobile control devices such as an automobile control device, an aircraft control device, a railroad vehicle control device, and a ship control device, a flight simulator, and the like.

Such an electronic device includes the magnetic element according to the embodiment as described above. Accordingly, it is possible to achieve the effects of the magnetic element, that is, high magnetic permeability over a wide frequency range, and to achieve downsizing and an increase in output of the electronic device.

### 5. Effects of Embodiment

As described above, amorphous alloy soft magnetic powder according to an embodiment includes a composition expressed by a composition formula in atomic ratio (FeₓCo₁₋ₓ)_{100-(a+b)}(Si_{y}B_{1-y})ₐM_{b}, where M is at least one type selected from the group consisting of C, S, P, Sn, Mo, Cu, and Nb, 0.73≤x≤0.85, 0.02≤y≤0.10, 13.0≤a≤19.0, and 0≤b≤2.0; and impurities.

The amorphous alloy soft magnetic powder according to the embodiment has an average circularity of 0.85 or more, an average aspect ratio of 1.20 or less, and an average particle size of 10 μm or more and 40 μm or less. In the amorphous alloy soft magnetic powder, a rate of decrease D in magnetic permeability accompanying an increase in frequency is 15% or less when the rate of decrease D is defined by (μₖ−μ_{M})/μₖ, where μₖ is the magnetic permeability at a frequency of 100 kHz, and μ_{M} is the magnetic permeability at a frequency of 100 MHz.

According to such a configuration, the particle size, the circularity, and the aspect ratio are optimized, and thus the amorphous alloy soft magnetic powder featuring excellent fillability is obtained. With such amorphous alloy soft magnetic powder, a compact featuring a high density and a high magnetic permeability ca n be produced. Furthermore, it is possible to produce a compact of which the magnetic permeability does not vary greatly among different frequencies, and features the magnetic permeability over a wide frequency range.

In the amorphous alloy soft magnetic powder according to the embodiment, a degree of crystallization of particles is preferably 15% or less.

With this configuration, the soft magnetism is more eminently improved by amorphization. As a result, an amorphous alloy soft magnetic powder featuring sufficiently high magnetic permeability and low coercive force can be obtained. Amorphous alloy soft magnetic powder with which a green compact featuring high magnetic permeability over a wide frequency range can be produced can be obtained.

A compact obtained by mixing the amorphous alloy soft magnetic powder according to the embodiment with 2 mass % of epoxy resin, drying the resultant powder at 50° C. for an hour to obtain granulated powder, pressing the granulated powder at 294.2 MPa (3 t/cm²) to obtain a green compact, and heating and curing the green compact at 150° C. for three hours preferably has a relative density of 65% or more.

With this configuration, the occupancy of the resin and the gap in the compact are sufficiently suppressed. As a result, sufficiently high occupancy of the amorphous alloy can be obtained. Thus, even higher magnetic permeability and saturation magnetic flux density of the compact can be achieved.

A compact obtained by mixing the amorphous alloy soft magnetic powder according to the embodiment with 2 mass % of epoxy resin, drying the resultant powder at 50° C. for an hour to obtain granulated powder, pressing the granulated powder at 294.2 MPa (3 t/cm²) to obtain a green compact, and heating and curing the green compact at 150° C. for three hours preferably has an iron loss of 11000 [kW/m³] or less when the iron loss is measured with a maximum magnetic flux density of 50 mT and at a measurement frequency of 900 kHz.

With such a configuration, amorphous alloy soft magnetic powder with which a magnetic element featuring a high efficiency can be produced can be obtained.

The saturation magnetic flux density Bs [T] of the amorphous alloy soft magnetic powder according to the embodiment obtained by 4π/10000×ρ×Mm=Bm is preferably 1.5 T or more and 2.2 T or less, where Mm [emu/g] is a maximum magnetization measured using a vibrating sample magnetometer and ρ [g/cm³] is a true density.

With such a configuration, amorphous alloy soft magnetic powder with which a magnetic element featuring a high saturation magnetic flux density can be produced can be obtained.

The dust core according to the embodiment includes the amorphous alloy soft magnetic powder according to the embodiment. Thus, a dust core featuring high magnetic permeability over a wide frequency range can be obtained.

The magnetic element according to the embodiment includes the dust core according to the embodiment. Thus, the magnetic element that contributes to downsizing and an increase in output of an electronic device can be obtained.

The electronic device according to the embodiment includes the magnetic element according to the embodiment. With this configuration, it is possible to achieve high performance and downsizing of the electronic device.

While the amorphous alloy soft magnetic powder, the dust core, the magnetic element, and the electronic device according to the present disclosure have been described above based on preferred embodiments, the present disclosure is not limited to these embodiments, and any component may be added to the embodiments.

While in the above-described embodiment, a dust core is described as an application example of the amorphous alloy soft magnetic powder of the present disclosure, the application example is not limited thereto and may be a magnetic fluid, a magnetic shielding sheet, a magnetic device such as a magnetic head, or the like. The shapes of the dust core and the magnetic element are not limited to those illustrated in the drawings and may have any shape.

### Examples

Next, specific examples of the present disclosure will be described.

### 6. Production of Dust Core

### 6.1. Sample No. 1

First, a raw material is melted in a high-frequency induction furnace and powdered by a rotating water flow atomization method, whereby amorphous alloy soft magnetic powder is obtained. The difference between the casting temperature and the melting point during the powder production and the outer diameter of the molten metal streamlet are shown in Table 3.

Next, the obtained amorphous alloy soft magnetic powder was heated at 360° C. for five minutes in a nitrogen atmosphere.

Next, the amorphous alloy soft magnetic powder was classified using a JIS test sieve having a nominal opening of 53 μm. The alloy composition of the amorphous alloy soft magnetic powder after classification is shown in Table 1. A solid emission spectrometer available from SPECTRO Analytical Instruments, model: SPECTROLAB, type: LAVMB08A was used for identifying the alloy composition.

Next, the average particle size of the obtained amorphous alloy soft magnetic powder was measured. The measurement was performed using Microtrac HRA9320-X100 available from Nikkiso Co., Ltd which is a laser diffraction-type particle size distribution measuring apparatus. For the obtained amorphous alloy soft magnetic powder, the average circularity, the average aspect ratio, and the degree of crystallization were measured. The measurement results are shown in Table 3.

Next, a mixture was obtained by mixing the obtained amorphous alloy soft magnetic powder with epoxy resin as a binder and toluene as an organic solvent. The amount of the epoxy resin added was 2 parts by mass with respect to 100 parts by mass of the amorphous alloy soft magnetic powder.

Next, the obtained mixed material was stirred, and then heated and dried at a temperature of 50° C. in an atmosphere for an hour to obtain a massive dried product. Next, the dried product was passed through a sieve having an opening of 400 μm and pulverized to obtain resultant powder.

Next, the obtained resultant powder was filled in a molding die, and a green compact was obtained based on the following molding conditions.
Molding method: press molding
Compact shape: ring shape
Dimensions of compact: an outer diameter of 14 mm, an inner diameter of 8 mm, and a thickness of 3 mm
Compacting force: 3 t/cm² (294.2 MPa)

Next, the green compact was heated at 150° C. for three hours in an atmosphere to cure the binder. Thus, a compact (dust core) was obtained.

### 6.2. Sample Nos. 2 to 17

Compacts were obtained in the same manner as in Sample No. 1, except that the amorphous alloy soft magnetic powder shown in Table 1 was used. The production conditions and various characteristics of the powder are shown in Table 3.

### 6.3. Sample Nos. 18 to 30

Compacts were obtained in the same manner as in Sample No. 1, except that the amorphous alloy soft magnetic powder shown in Table 2 was used. The production conditions and various characteristics of the powder are shown in Table 4.

### 6.4. Sample No. 31

Amorphous alloy soft magnetic powder was produced and a compact was obtained in the same manner as in Sample No. 1 except that a water atomization method was used instead of the rotating water flow atomization method. The cooling rate by the water atomization method was as shown in Table 2. The production conditions and various characteristics of the powder are shown in Table 4.

### 6.5. Sample No. 32

A compact was obtained in the same manner as in Sample No. 31, except that the amorphous alloy soft magnetic powder shown in Table 2 was used. The production conditions and various characteristics of the powder are shown in Table 4.

TABLE 1

| | | | Alloy composition | | | | Alloy composition ratio | | | | | | | | | | | |
|---|---|---|---|---|---|---|---|---|---|---|---|---|---|---|---|---|---|---|
| | | Cooling | formula | | | | | | | | M | | | | | | | |
| Sample | Production | rate | x | y | a | b | Fe | Co | Si | B | C | S | P | Sn | Mo | Cu | Nb | Sum |

| No. | Category | method | K/sec | — | — | — | — | atom % | | | | |
|---|---|---|---|---|---|---|---|---|---|---|---|---|
| No. 1 | Example | Rotating water | 10⁷ | 0.74 | 0.06 | 16.00 | 0.00 | 62.2 | 21.8 | 1.0 | 15.0 | 100.0 |
| No. 2 | Example | Rotating water | 10⁷ | 0.76 | 0.06 | 16.00 | 0.00 | 63.8 | 20.2 | 1.0 | 15.0 | 100.0 |
| No. 3 | Example | Rotating water | 10⁷ | 0.79 | 0.06 | 16.00 | 0.00 | 66.4 | 17.6 | 1.0 | 15.0 | 100.0 |
| No. 4 | Example | Rotating water | 10⁷ | 0.82 | 0.06 | 16.00 | 0.00 | 68.9 | 15.1 | 1.0 | 15.0 | 100.0 |
| No. 5 | Example | Rotating water | 10⁷ | 0.84 | 0.06 | 16.00 | 0.00 | 70.6 | 13.4 | 1.0 | 15.0 | 100.0 |
| No. 6 | Example | Rotating water | 10⁷ | 0.79 | 0.03 | 16.00 | 0.00 | 66.4 | 17.6 | 0.5 | 15.5 | 100.0 |
| No. 7 | Example | Rotating water | 10⁷ | 0.79 | 0.05 | 16.00 | 0.00 | 66.4 | 17.6 | 0.8 | 15.2 | 100.0 |
| No. 8 | Example | Rotating water | 10⁷ | 0.79 | 0.09 | 16.00 | 0.00 | 66.4 | 17.6 | 1.4 | 14.6 | 100.0 |
| No. 9 | Example | Rotating water | 10⁷ | 0.79 | 0.06 | 14.00 | 0.00 | 67.9 | 16.1 | 0.8 | 13.2 | 100.0 |
| No. 10 | Example | Rotating water | 10⁷ | 0.78 | 0.07 | 18.00 | 0.00 | 64.0 | 16.0 | 1.3 | 16.7 | 100.0 |
| No. 11 | Comparative | Rotating water | 10⁷ | 0.71 | 0.06 | 16.00 | 0.00 | 59.6 | 24.4 | 1.0 | 15.0 | 100.0 |
| | example | | | | | | | | | | | |
| No. 12 | Comparative | Rotating water | 10⁷ | 0.87 | 0.06 | 16.00 | 0.00 | 73.1 | 10.9 | 1.0 | 15.0 | 100.0 |
| | example | | | | | | | | | | | |
| No. 13 | Comparative | Rotating water | 10⁷ | 0.79 | 0.01 | 16.00 | 0.00 | 66.4 | 17.6 | 0.2 | 15.8 | 100.0 |
| | example | | | | | | | | | | | |
| No. 14 | Comparative | Rotating water | 10⁷ | 0.79 | 0.12 | 16.00 | 0.00 | 66.4 | 17.6 | 1.9 | 14.1 | 100.0 |
| | example | | | | | | | | | | | |
| No. 15 | Comparative | Rotating water | 10⁷ | 0.80 | 0.06 | 10.00 | 0.00 | 72.0 | 18.0 | 0.5 | 9.5 | 100.0 |
| | example | | | | | | | | | | | |
| No. 16 | Comparative | Rotating water | 10⁷ | 0.80 | 0.06 | 21.00 | 0.00 | 83.2 | 15.8 | 1.1 | 20.0 | 100.0 |
| | example | | | | | | | | | | | |
| No. 17 | Comparative | Rotating water | 10⁷ | 0.79 | 0.06 | 16.00 | 0.00 | 66.4 | 17.6 | 1.0 | 15.0 | 100.0 |
| | example | | | | | | | | | | | |

TABLE 2

| | | | | Alloy composition | | | | Alloy composition ratio | | | | | | | | | | | |
|---|---|---|---|---|---|---|---|---|---|---|---|---|---|---|---|---|---|---|---|
| | | | | formula | | | | | | | | M | | | | | | | |
| Sample | | Production | Cooling | x | y | a | b | Fe | Co | Si | B | C | S | P | Sn | Mo | Cu | Nb | Sum |
| No. | Category | method | rate | — | — | — | — | atom % | | | | | | | | | | | |
| No. 18 | Example | Rotating water | 10⁷ | 0.79 | 0.06 | 16.00 | 0.50 | 66.0 | 17.5 | 1.0 | 15.0 | 0.5 | | | | | | | 100.0 |
| No. 19 | Example | Rotating water | 10⁷ | 0.79 | 0.06 | 16.00 | 1.00 | 65.6 | 17.4 | 1.0 | 15.0 | 1.0 | | | | | | | 100.0 |
| No. 20 | Example | Rotating water | 10⁷ | 0.79 | 0.06 | 16.00 | 1.50 | 65.2 | 17.3 | 1.0 | 15.0 | 1.5 | | | | | | | 100.0 |
| No. 21 | Example | Rotating water | 10⁷ | 0.79 | 0.06 | 16.00 | 1.00 | 65.6 | 17.4 | 1.0 | 15.0 | | 1.0 | | | | | | 100.0 |
| No. 22 | Example | Rotating water | 10⁷ | 0.79 | 0.06 | 16.00 | 1.00 | 65.6 | 17.4 | 1.0 | 15.0 | | | 1.0 | | | | | 100.0 |
| No. 23 | Example | Rotating water | 10⁷ | 0.79 | 0.00 | 16.00 | 1.00 | 65.6 | 17.4 | 1.0 | 15.0 | | | | 1.0 | | | | 100.0 |
| No. 24 | Example | Rotating water | 10⁷ | 0.79 | 0.06 | 16.00 | 1.00 | 65 6 | 17.4 | 1.0 | 15.0 | | | | | 1.0 | | | 100.0 |
| No. 25 | Example | Rotating water | 10⁷ | 0.79 | 0.00 | 16.00 | 1.00 | 65.6 | 17.4 | 1.0 | 15.0 | | | | | | 1.0 | | 100.0 |
| No. 26 | Example | Rotating water | 10⁷ | 0.78 | 0.06 | 16.00 | 1.00 | 65.6 | 17.4 | 1.0 | 15.0 | | | | | | | 1.0 | 100.0 |
| No. 27 | Example | Rotating water | 10⁷ | 0.79 | 0.06 | 16.00 | 1.00 | 65.6 | 17.4 | 1.0 | 15.0 | 0.5 | 0.5 | | | | | | 100.0 |
| No. 28 | Example | Rotating water | 10⁷ | 0.79 | 0.06 | 16.00 | 1.00 | 65.6 | 17.4 | 1.0 | 15.0 | 0.5 | | 0.5 | | | | | 100.0 |
| No. 29 | Comparative | Rotating water | 10⁷ | 0.79 | 0.06 | 16.00 | 3.00 | 64.0 | 17.0 | 1.0 | 15.0 | 3.0 | | | | | | | 100.0 |
| | example | | | | | | | | | | | | | | | | | | |
| No. 30 | Comparative | Rotating water | 10⁷ | 0.82 | 0.06 | 15.00 | 3.00 | 67.2 | 14.8 | 0.9 | 14.1 | 2.0 | 1.0 | | | | | | 100.0 |
| | example | | | | | | | | | | | | | | | | | | |
| No. 31 | Comparative | Water | 10⁵ | 0.79 | 0.05 | 16.00 | 0.00 | 66.4 | 17.6 | 0.8 | 15.2 | | | | | | | | 100.0 |
| | example | | | | | | | | | | | | | | | | | | |
| No. 32 | Comparative | Water | 10⁵ | 0.79 | 0.06 | 16.00 | 1.00 | 65.6 | 17.4 | 1.0 | 15.0 | 1.0 | | | | | | | 100.0 |
| | example | | | | | | | | | | | | | | | | | | |

TABLE 3

| | | Production conditions | | | | | |
|---|---|---|---|---|---|---|---|
| | | Difference | Outer | | | | |
| | | between | diameter | | | | |
| | | casting | of | Configuration of amorphous alloy soft magnetic powder | | | |
| | | and melting | streamlet | | Average | Average | |
| | | point | of molten | Average | aspect | particle | Degree of |
| Sample | | temperature | metal | circularity | ratio | size | crystallization |
| No. | Category | ° C. | mm | — | — | μm | % |
| No. 1 | Example | 140 | 1.0 | 0.86 | 1.20 | 23.5 | 10 |
| No. 2 | Example | 210 | 1.0 | 0.91 | 1.10 | 26.0 | 8 |
| No. 3 | Example | 230 | 1.0 | 0.92 | 1.08 | 28.8 | 5 |
| No. 4 | Example | 200 | 1.0 | 0.90 | 1.12 | 30.4 | 7 |
| No. 5 | Example | 160 | 1.0 | 0.87 | 1.18 | 34.3 | 9 |
| No. 6 | Example | 180 | 1.0 | 0.89 | 1.14 | 27.3 | 7 |
| No. 7 | Example | 240 | 1.0 | 0.92 | 1.06 | 29.5 | 5 |
| No. 8 | Example | 180 | 1.0 | 0.89 | 1.14 | 20.4 | 7 |
| No. 9 | Example | 130 | 1.0 | 0.87 | 1.18 | 17.3 | 11 |
| No. 10 | Example | 130 | 1.0 | 0.87 | 1.18 | 12.8 | 11 |
| No. 11 | Comparative example | 60 | 1.0 | 0.83 | 1.26 | 28.0 | 15 |
| No. 12 | Comparative example | 80 | 1.0 | 0.84 | 1.24 | 35.0 | 14 |
| No. 13 | Comparative example | 110 | 1.0 | 0.86 | 1.20 | 20.4 | 13 |
| No. 14 | Comparative example | 120 | 1.0 | 0.88 | 1.16 | 16.3 | 12 |
| No. 15 | Comparative example | 60 | 1.0 | 0.85 | 1.22 | 23.0 | 15 |
| No. 16 | Comparative example | 70 | 1.0 | 0.84 | 1.24 | 29.2 | 14 |
| No. 17 | Comparative example | 70 | 1.0 | 0.82 | 1.26 | 28.4 | 18 |

TABLE 4

| | | Production conditions | | | | | |
|---|---|---|---|---|---|---|---|
| | | Difference | Outer | | | | |
| | | between | diameter | | | | |
| | | casting | of | Configuration of amorphous alloy soft magnetic powder | | | |
| | | temperature | streamlet | | Average | Average | |
| | | and melting | of molten | Average | aspect | particle | Degree of |
| Sample | | point | metal | circularity | ratio | size | crystallization |
| No. | Category | ° C. | mm | — | — | um | % |
| No.18 | Example | 230 | 1.0 | 0.92 | 1.08 | 30.2 | 6 |
| No.19 | Example | 220 | 1.0 | 0.93 | 1.06 | 29.2 | 4 |
| No.20 | Example | 200 | 1.0 | 0.90 | 1.12 | 28.5 | 5 |
| No.21 | Example | 250 | 1.0 | 0.92 | 1.08 | 27.8 | 10 |
| No.22 | Example | 260 | 1.0 | 0.90 | 1.12 | 23.5 | 12 |
| No.23 | Example | 300 | 1.0 | 0.89 | 1.14 | 24.5 | 16 |
| No.24 | Example | 180 | 1.0 | 0.89 | 1.14 | 25.5 | 7 |
| No.25 | Example | 240 | 1.0 | 0.91 | 1.10 | 23.5 | 5 |
| No.26 | Example | 260 | 1.0 | 0.90 | 1.12 | 22.4 | 12 |
| No.27 | Example | 220 | 1.0 | 0.94 | 1.04 | 30.2 | 3 |
| No 28 | Example | 220 | 1.0 | 0.94 | 1.04 | 28.4 | 3 |
| No.29 | Comparative example | 70 | 1.0 | 0.83 | 1.26 | 25.5 | 14 |
| No.30 | Comparative example | 70 | 1.0 | 0.84 | 1.24 | 23.5 | 15 |
| No.31 | Comparative example | 70 | 1.0 | 0.84 | 1.24 | 29.5 | 14 |
| No.32 | Comparative example | 320 | 1.0 | 0.88 | 1.16 | 28.6 | 30 |

In Tables 1 to 4, of amorphous alloy soft magnetic powders of the respective sample numbers, those corresponding to the present disclosure are shown as “Examples”, and those not corresponding to the present disclosure are shown as “Comparative Examples”.

### 7. Evaluation of Amorphous Alloy Soft Magnetic Powder and Compact

### 7.1. Powder Characteristics

An apparent density AD and a tap density TD of the produced amorphous alloy soft magnetic powder were measured. A relative value of the tap density TD with respect to the apparent density AD when the apparent density AD is defined as 100, that is, a ratio of the tap density to the apparent density was calculated. The measurement results and the calculation results are shown in Tables 5 and 6.

### 7.2. Magnetic Permeability

The magnetic permeability at each of the measurement frequencies 100 kHz and 100 MHz was measured for the amorphous alloy soft magnetic powder of Examples and Comparative Examples. The rate of decrease D in magnetic permeability accompanying an increase in frequency was calculated. The measurement results and the calculation results are shown in Tables 5 and 6.

### 7.3. Coercive Force

The coercive force of the amorphous alloy soft magnetic powder of each Example and each Comparative Example was measured. The measurement results are shown in Table 5 and Table 6.

### 7.4. Saturation Magnetic Flux Density

The maximum magnetization of the compact obtained in each Example and each Comparative Example was measured, and then the saturation magnetic flux density was calculated based on the measurement result. The calculation results are shown in Table 5 and Table 6.

### 7.5. Relative Density

The density of the compact obtained in each Example and each Comparative Example was measured, and the relative density was calculated. The calculation results are shown in Table 5 and Table 6.

### 7.6. Iron Loss

Iron loss was measured for the compacts obtained in each Example and each Comparative Example. The measurement results are shown in Table 5 and Table 6.

TABLE 5

| | | Evaluation results of amorphous alloy soft magnetic powder | | | | | | | | | |
|---|---|---|---|---|---|---|---|---|---|---|---|
| | | | | Ratio of tap | | | | | Saturation | | |
| | | | | density to | Magnetic permeability | | | | magnetic | | |
| | | Apparent | Tap | apparent | 100 | 100 | Rate of | Coercive | flux | Relative | Iron |
| Sample | | density | density | density | kHz | MHz | decrease D | force | density | density | loss |
| No. | Category | g/cm³ | g/cm³ | — | — | — | % | Oe | T | % | kW/m³ |
| No. 1 | Example | 4.55 | 4.70 | 103 | 18.5 | 16.0 | 13.5 | 1.37 | 1.62 | 64 | 10642 |
| No. 2 | Example | 4.60 | 5.00 | 109 | 18.7 | 17.0 | 9.1 | 1.35 | 1.63 | 67 | 10487 |
| No. 3 | Example | 4.63 | 5.10 | 110 | 18.9 | 17.1 | 9.5 | 1.34 | 1.65 | 68 | 10409 |
| No. 4 | Example | 4.61 | 5.00 | 108 | 20.5 | 18.3 | 10.7 | 1.37 | 1.63 | 67 | 10642 |
| No. 5 | Example | 4.58 | 4.80 | 105 | 21.0 | 18.5 | 11.9 | 1.45 | 1.64 | 65 | 11264 |
| No. 6 | Example | 4.57 | 4.90 | 107 | 19.4 | 17.5 | 9.8 | 1.40 | 1.63 | 66 | 10875 |
| No. 7 | Example | 4.63 | 5.10 | 110 | 19.2 | 18.2 | 5.2 | 1.35 | 1.65 | 88 | 10487 |
| No. 8 | Example | 4.56 | 4.90 | 107 | 19.1 | 17.2 | 9.9 | 1.36 | 1.63 | 66 | 10564 |
| No. 9 | Example | 4.48 | 4.70 | 105 | 18.6 | 16.2 | 12.9 | 1.52 | 1.61 | 65 | 11807 |
| No. 10 | Example | 4.47 | 4.70 | 105 | 18.4 | 15.8 | 14.1 | 1.48 | 1.60 | 65 | 11497 |
| No. 11 | Comparative example | 4.35 | 4.45 | 102 | 15.0 | 12.0 | 20.0 | 2.31 | 1.25 | 63 | 17944 |
| No. 12 | Comparative example | 4.34 | 4.42 | 102 | 22.5 | 20.0 | 11.1 | 3.50 | 1.08 | 63 | 27188 |
| No. 13 | Comparative example | 4.56 | 4.75 | 104 | 10.2 | 8.5 | 16.7 | 7.56 | 0.98 | 64 | 58726 |
| No. 14 | Comparative example | 4.45 | 4.72 | 106 | 23.0 | 18.0 | 21.7 | 5.42 | 1.54 | 66 | 42103 |
| No. 15 | Comparative example | 4.50 | 4.63 | 103 | 18.5 | 16.0 | 13.5 | 2.56 | 1.18 | 64 | 19886 |
| No. 16 | Comparative example | 4.43 | 4.50 | 102 | 17.4 | 15.6 | 10.3 | 3.65 | 1.07 | 63 | 28353 |
| No. 17 | Comparative example | 4.35 | 4.50 | 103 | 20.6 | 16.0 | 22.3 | 3.25 | 1.65 | 64 | 25246 |

TABLE 6

| | | Evaluation results of amorphous alloy soft magnetic powder | | | | | | | | | |
|---|---|---|---|---|---|---|---|---|---|---|---|
| | | | | Ratio of tap | | | | | Saturation | | |
| | | | | density to | Magnetic permeability | | | | magnetic | | |
| | | Apparent | Tap | apparent | 100 | 100 | Rate of | Coercive | flux | Relative | Iron |
| Sample | | density | density | density | kHz | MH2 | decrease D | force | density | density | loss |
| No. | Category | g/cm³ | g/cm³ | — | — | — | % | Oe | T | % | kW/m³ |
| No. 18 8 | Example | 4.64 | 5.10 | 110 | 19.3 | 17.5 | 9.3 | 1.33 | 1.66 | 68 | 10331 |
| No. 19 9 | Example | 4.63 | 5.20 | 112 | 19.5 | 18.2 | 6.7 | 1.32 | 1.67 | 69 | 10254 |
| No. 20 0 | Example | 4.65 | 5.00 | 108 | 19.4 | 18.0 | 7.2 | 1.34 | 1.66 | 66 | 10409 |
| No. 21 1 | Example | 4.62 | 5.10 | 110 | 19.1 | 17.0 | 11.0 | 1.34 | 1.65 | 68 | 10409 |
| No. 22 2 | Example | 4.61 | 5.00 | 108 | 19.0 | 17.0 | 10.5 | 1.35 | 1.65 | 67 | 10487 |
| No. 23 3 | Example | 4.58 | 4.90 | 107 | 18.0 | 15.4 | 14.4 | 1.50 | 1.64 | 66 | 11652 |
| No. 24 4 | Example | 4.56 | 4.90 | 107 | 19.4 | 17.5 | 9.8 | 1.34 | 1.65 | 66 | 10409 |
| No. 25 5 | Example | 4.66 | 5.10 | 109 | 19.2 | 18.2 | 5.2 | 1.33 | 1.66 | 68 | 10331 |
| No. 26 6 | Example | 4.63 | 5.00 | 108 | 19.0 | 17.0 | 10.5 | 1.34 | 1.66 | 67 | 10409 |
| No. 27 7 | Example | 4.63 | 5.30 | 114 | 19.5 | 18.6 | 4.6 | 1.31 | 1.68 | 71 | 10176 |
| No. 28 8 | Example | 4.66 | 5.30 | 114 | $9.7 | 18.8 | 4.6 | 1.31 | 1.68 | 70 | 10176 |
| No. 29 9 | Comparative example | 4.45 | 4.52 | 102 | 19.8 | 17.4 | 12.1 | 1.96 | 1.41 | 63 | 15225 |
| No. 30 0 | Comparative example | 4.36 | 4.45 | 102 | 19.6 | 17.0 | 13.3 | 2.04 | 1.36 | 63 | 15847 |
| No. 31 1 | Comparative example | 4.33 | 4.42 | 102 | 18.4 | 16.5 | 10.3 | 20.60 | 1.44 | 63 | 160021 |
| No. 32 2 | Comparative example | 4.35 | 4.62 | 106 | 20.6 | 16.0 | 22.3 | 18.50 | 1.36 | 66 | 143708 |

As is clear from Table 5 and Table 6, the amorphous alloy soft magnetic powder of each Example has an optimized average particle size and features high fillability at the time of compaction. Furthermore, the average circularity and the average aspect ratio are both excellent. Therefore, when the amorphous alloy soft magnetic powder of each example is formed into a compact, the occupancy ratio of the amorphous alloy is high, whereby high magnetic permeability can be achieved. The amorphous alloy soft magnetic powder of each Example achieves high magnetic permeability at both measurement frequencies that are 100 kHz and 100 MHz. Therefore, it was found that with the amorphous alloy soft magnetic powder of each Example, a compact featuring high magnetic permeability over a wide frequency range can be produced.

FIG. 7 is a graph showing the frequency dependence of magnetic permeability measured for the amorphous alloy soft magnetic powder of Sample No. 3 and Sample No. 17.

As shown in FIG. 7, the magnetic permeability measured for the amorphous alloy soft magnetic powder of Sample No. 17, which is a Comparative Example, decreased relatively greatly with a change in measurement frequency from 100 kHz to 100000 kHz (100 MHz). On the other hand, it can be seen that the rate of decrease in magnetic permeability measured for the amorphous alloy soft magnetic powder of Sample No. 3, which is an Example, was relatively small.

What is claimed is:

1. Amorphous alloy soft magnetic powder comprising:
a composition expressed by a composition formula in atomic ratio (FeₓCo₁₋ₓ)_{100-(a+b)}(Si_{y}B_{1-y})ₐM_{b},
where M is at least one type selected from the group consisting of C, S, P, Sn, Mo, Cu, and Nb,
$$0.73 \leq x \leq 0.85 ,$$
$$0.02 \leq y \leq 0 \text{.10} ,$$
$$13. \leq a \leq 1 9. ,$$
$$and 0 \leq b \leq 2. ;$$
and
impurities, wherein
the amorphous alloy soft magnetic powder has
an average circularity of 0.85 or more,
an average aspect ratio of 1.20 or less, and
an average particle size of 10 μm or more and 40 μm or less and
in the amorphous alloy soft magnetic powder, a rate of decrease D in magnetic permeability accompanying an increase in frequency is 15% or less when the rate of decrease D is defined by (μₖ−μ_{M})/μₖ, where μₖ is a magnetic permeability at a frequency of 100 kHz, and μ_{M} is a magnetic permeability at a frequency of 100 MHz.

2. The amorphous alloy soft magnetic powder according to claim 1, wherein
a degree of crystallization of particles is 15% or less.

3. The amorphous alloy soft magnetic powder according to claim 1, wherein
a compact obtained by mixing the amorphous alloy soft magnetic powder with 2 mass % of epoxy resin, drying resultant powder at 50° C. for an hour to obtain granulated powder, pressing the granulated powder at 294.2 MPa (3 t/cm²) to obtain a green compact, and heating and curing the green compact at 150° C. for three hours has a relative density of 65% or more.

4. The amorphous alloy soft magnetic powder according to claim 1, wherein
a compact obtained by mixing the amorphous alloy soft magnetic powder with 2 mass % of epoxy resin, drying resultant powder at 50° C. for an hour to obtain granulated powder, pressing the granulated powder at 294.2 MPa (3 t/cm²) to obtain a green compact, and heating and curing the green compact at 150° C. for three hours has an iron loss of 11000 [kW/m³] or less when the iron loss is measured with a maximum magnetic flux density of 50 mT and at a measurement frequency of 900 kHz.

5. The amorphous alloy soft magnetic powder according to claim 1, wherein
a saturation magnetic flux density Bs [T] of the amorphous alloy soft magnetic powder obtained by 4π/10000×ρ×Mm=Bm is 1.5 T or more and 2.2 T or less, where Mm [emu/g] is a maximum magnetization measured using a vibrating sample magnetometer and ρ [g/cm³] is a true density.

6. A dust core comprising the amorphous alloy soft magnetic powder according to claim 1.

7. A magnetic element comprising the dust core according to claim 6.

8. An electronic device comprising the magnetic element according to claim 7.
